(19) United States
(12) Patent Application Publication
(10) Pub. No.: US 2022/0374819 A1
(43) Pub. Date: Nov. 24, 2022

(54) MANAGEMENT SYSTEM, MANAGEMENT SERVER, AND MANAGEMENT METHOD

(71) Applicant: KYOCERA Corporation, Kyoto (JP)

(72) Inventors: Yuki YAMADA, Yokohama-shi (JP); Takaomi ARAKI, Yokohama-shi (JP)

(73) Assignee: KYOCERA Corporation, Kyoto (JP)

(21) Appl. No.: 17/817,576

(22) Filed: Aug. 4, 2022

Related U.S. Application Data
(63) Continuation of application No. PCT/JP2021/004131, filed on Feb. 4, 2021.

(30) Foreign Application Priority Data
Feb. 7, 2020 (JP) 2020-019878

(51) Int. Cl. G06Q 10/08; G06Q 10/02; B65G 1/04

(52) U.S. Cl. CPC G06Q 10/08; G06Q 10/02; B65G 1/0485

(57) ABSTRACT

A management system 1 includes a storage apparatus 100 including a storage box that stores a package to be delivered, and a management server 200 that manages the storage apparatus 100, and automatically reserves the storage box that stores an undelivered package. The management server 200 executes prioritization processing of setting priority to each of the undelivered packages, based on package information related to the undelivered packages, and reservation processing of reserving the storage box in order from a package having the priority of high, based on the package information and storage apparatus information related to the storage apparatus 100.

### RELATED APPLICATIONS

The present application is a continuation based on PCT Application No. PCT/JP2021/004131, filed on Feb. 4, 2021, which claims the benefit of Japanese Patent Application No. 2020-019878 filed on Feb. 7, 2020. The content of which is incorporated by reference herein in their entirety.

### TECHNICAL FIELD

The present invention relates to a management system, a management server, and a management method.

### BACKGROUND OF INVENTION

Patent Document 1 describes a system including a storage apparatus that stores a package in a storage box and temporarily keeps the package, a management server that manages information in the storage apparatus, and a delivery person's terminal of a delivery person who delivers the package, in which the management server transmits information of a storage status and a reservation status of the storage box to the delivery person's terminal.

In the system, when the management server receives information indicating a request for reservation of the storage box of the storage apparatus from the delivery person's terminal, the management server performs reservation processing regarding the storage box for which the reservation is requested, and locks the storage box and prohibits storage of packages.

### CITATION LIST

### Patent Literature

Patent Document 1: Japanese application publication No. 2018-72885

### SUMMARY

In a first aspect, a management system includes: a storage apparatus including a storage box configured to store a package to be delivered; and a server configured to manage the storage apparatus and automatically reserve the storage box configured to store the package. The server is configured to execute prioritization processing of setting priority to the package, based on package information related to the package, and reservation processing of reserving the storage box in order from a package having the priority of high, based on the package information and storage apparatus information related to the storage apparatus.

In a second aspect, a management server is configured to manage a storage apparatus including a storage box configured to store a package to be delivered. The management server includes a processor configured to automatically reserve the storage box configured to store the package. The processor is configured to execute prioritization processing of setting priority to the package, based on package information related to the package, and reservation processing of reserving the storage box in order from a package having the priority of high, based on the package information and storage apparatus information related to the storage apparatus.

In a third aspect, a management method manages a storage apparatus including a storage box configured to store a package to be delivered. The management method includes automatically reserving the storage box configured to store the package. The reserving includes setting priority to the package, based on package information related to the package, and reserving the storage box in order from a package having the priority of high, based on the package information and storage apparatus information related to the storage apparatus.

### BRIEF DESCRIPTION OF DRAWINGS

FIG. 1 is a diagram illustrating a configuration of a management system according to an embodiment.

FIG. 2 is a diagram illustrating a configuration of a storage apparatus according to an embodiment.

FIG. 3 is a diagram illustrating an example of external appearance of a front side of the storage apparatus according to an embodiment.

FIG. 4 is a diagram illustrating a configuration of a management server according to an embodiment.

FIG. 5 is a diagram illustrating storage apparatus information according to an embodiment.

FIG. 6 is a diagram illustrating package information according to an embodiment.

FIG. 7 is a diagram illustrating prioritization processing according to an embodiment.

FIG. 8 is a diagram illustrating reservation processing according to an embodiment.

FIG. 9 is a diagram illustrating processing at the time of package retrieval according to an embodiment.

### DESCRIPTION OF EMBODIMENTS

The system described in Patent Literature 1 has the following problem: when a storage box is reserved, a delivery person needs to visually check a selection screen displayed on a delivery person's terminal and manually select any storage box to reserve the storage box, which makes reservation operation complicated and poses a large burden on the delivery person through the reservation operation.

In view of this, the present disclosure has an object to reduce a burden of reservation operation for a storage box.

Embodiments will be described with reference to the drawings. In the description of the drawings, the same or similar parts are denoted by the same or similar reference signs.

### Configuration of Management System

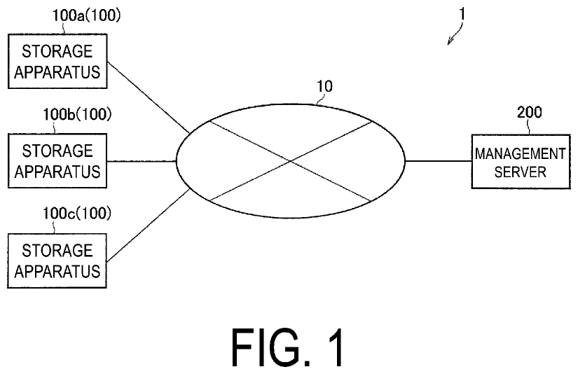

First, a configuration of a management system according to an embodiment will be described. FIG. 1 is a diagram illustrating a configuration of the management system 1 according to an embodiment.

As illustrated in FIG. 1, the management system 1 includes a plurality of storage apparatuses 100 (storage apparatuses 100a to 100c) and a management server 200. Note that, in FIG. 1, an example in which the number of storage apparatuses 100 is three is illustrated; however, the number of storage apparatuses 100 may be one, two, or four or more. The storage apparatuses 100 and the management server 200 perform communication to each other via a network 10.

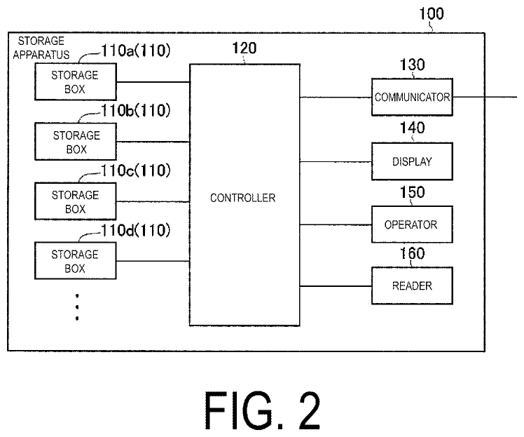

Each storage apparatus 100 is an apparatus including a storage box 110 (not illustrated in FIG. 1; see FIG. 2) that stores a package to be delivered. Each storage apparatus 100 is installed in a predetermined facility. The facility in which the storage apparatus 100 is installed may be, for example, a detached residence, or a housing complex such as an apartment house and a condominium. Such a storage apparatus 100 may be referred to as a delivery locker. Alternatively, the facility in which the storage apparatus 100 is installed may be a public place such as a station, a commercial facility, or the like. The description below is given on the assumption that the storage apparatus 100 is a delivery locker that is installed in a common-use space of a housing complex or the like.

The management server 200 is a server that manages the storage apparatus 100 via communication with the storage apparatus 100. For example, the management server 200 manages an availability status of each storage box 110 of the corresponding storage apparatus 100. The management server 200 acquires information related to each package to be delivered (undelivered package) via communication with a server of a delivery company, automatically reserves a storage box 110 to store the undelivered package, and locks the storage box 110. When the management server 200 reserves the storage box 110 regarding the package, the management server 200 notifies, through electronic mail or the like, a terminal that is owned by a recipient of the package, of the fact that the storage box 110 has been reserved.

After the storage box 110 is reserved, a delivery person (delivery driver) of the delivery company causes the storage apparatus 100 to read an identifier (for example, an invoice number) of the package. The management server 200 opens a door of the reserved storage box 110, based on the identifier of the package. Then, when the management server 200 detects that the package is stored in the reserved storage box 110 and the door is closed, the management server 200 locks the storage box 110, and notifies, through electronic mail or the like, the terminal that is owned by the recipient of the package, of the fact that the package has been stored in the storage box 110.

In the management system 1 configured as described above, the management server 200 executes prioritization processing of setting priority to each of the undelivered packages based on package information related to the undelivered packages, and reservation processing of reserving the storage boxes 110 in order from a package having high priority based on the package information and storage apparatus information related to the storage apparatus 100.

This enables automatic reservation of the storage boxes 110, and efficient reservation of the storage boxes 110. This eliminates the need of reservation operation of the storage boxes 110 by a delivery person, and can thus reduce a burden of the reservation operation of the storage boxes 110.

### Configuration of Storage Apparatus

Next, a configuration of the storage apparatus 100 according to an embodiment will be described. FIG. 2 is a diagram illustrating a configuration of the storage apparatus 100 according to an embodiment.

As illustrated in FIG. 2, the storage apparatus 100 includes a plurality of storage boxes 110 (storage boxes 110a, 110b, 110c, 110d, . . . ), a controller 120, a communicator 130, a display 140, an operator 150, and a reader 160.

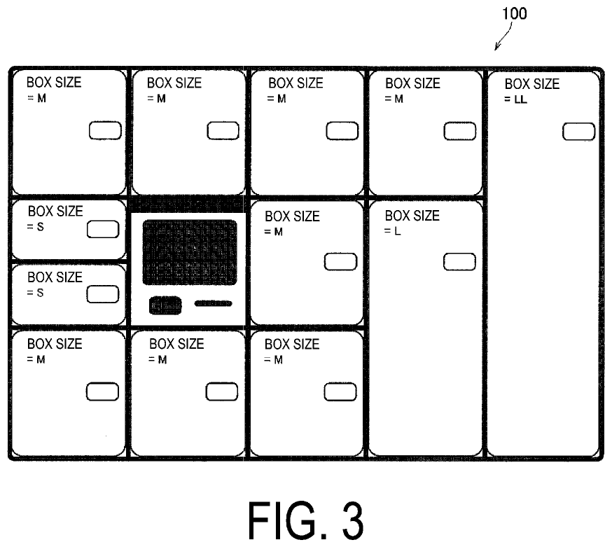

The storage box 110 includes an opening part that allows storage or retrieval of a package, a door that closes the opening part, a locking mechanism for locking the door, and a sensor that detects storage of a package. In order to enable storage of packages of various package sizes, a plurality of storage boxes 110 are provided for each size. FIG. 3 is a diagram illustrating an example of external appearance of a front side of the storage apparatus 100. In the example illustrated in FIG. 3, two storage boxes 110 having a box size of “S”, eight storage boxes 110 having a box size of “M”, one storage box 110 having a box size of “L”, and one storage box 110 having a box size of “LL” are provided.

The controller 120 controls the storage boxes 110, the communicator 130, the display 140, the operator 150, and the reader 160. The controller 120 includes at least one processor and at least one memory. The controller 120 controls locking and unlocking of the storage boxes 110 according to an instruction that the communicator 130 receives from the management server 200. The controller 120 transmits an open/close status of the door of the storage boxes 110 and detection results of the sensor of the storage boxes 110 and/or details of operation performed on the operator 150 and reading results of the reader 160 and the like from the communicator 130 to the management server 200.

The communicator 130 communicates with the management server 200. The communicator 130 includes a communication interface connected to the network 10 in a wired or wireless manner. The display 140 displays various pieces of information under control of the controller 120. The operator 150 receives operation from a delivery person or a recipient. The display 140 and the operator 150 may be integrated as a touch panel display. The reader 160 reads an invoice number or the like.

### Configuration of Management Server

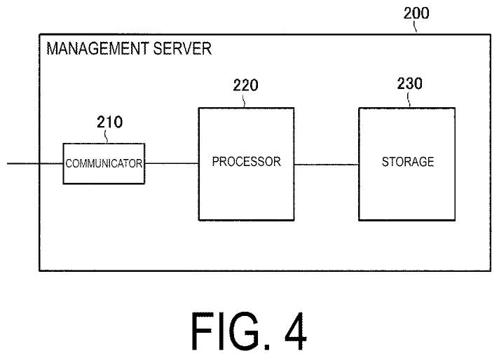

Next, a configuration of the management server 200 according to an embodiment will be described. FIG. 4 is a diagram illustrating a configuration of the management server 200 according to an embodiment.

As illustrated in FIG. 4, the management server 200 includes a communicator 210, a processor 220, and a storage 230.

The communicator 210 communicates with the storage apparatus 100. The communicator 210 includes a communication interface connected to the network 10 in a wired or wireless manner. The communicator 210 transmits a lock instruction or an unlock instruction to the storage apparatus 100. The communicator 210 receives a door open/close status of the storage boxes 110 and detection results of the sensor of the storage boxes 110 and/or details of operation performed on the operator 150 and reading results of the reader 160 and the like from the storage apparatus 100. In addition, the communicator 210 receives the package information related to each package to be delivered (undelivered package) from the server of the delivery company.

The processor 220 executes various types of information processing, based on information received by the communicator 210 and information stored in the storage 230. The processor 220 includes at least one processor. The storage 230 includes at least one memory. The storage 230 stores the storage apparatus information related to each storage apparatus 100 and the package information related to each package. The processor 220 manages the storage apparatus information and the package information.

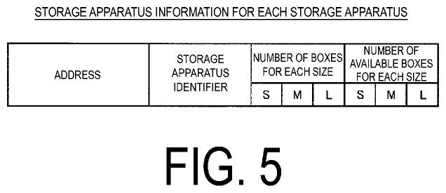

FIG. 5 is a diagram illustrating the storage apparatus information according to an embodiment.

As illustrated in FIG. 5, the storage apparatus information includes, for each storage apparatus 100, an address of the facility in which the storage apparatus 100 is installed, an identifier of the storage apparatus 100, the number of boxes for each box size (in the example of FIG. 5, “S”, “M”, and “L”) of the storage apparatus 100, and the number of available boxes for each box size of the storage apparatus 100. The available box refers to a storage box 110 that can be reserved.

The storage apparatus information includes, for each storage apparatus 100, a status (availability status) of each storage box 110 of the storage apparatus 100. The status of the storage box 110 is determined depending on whether there is a package stored in the storage box 110 and whether the storage box 110 is reserved. When there is no package stored in the storage box 110 and the storage box 110 is not reserved, the storage box 110 can be reserved (that is, available). Otherwise, the storage box 110 cannot be reserved.

When the storage box 110 is reserved, the processor 220 updates the storage apparatus information. When a package is stored in the storage box 110 or when a package is retrieved from the storage box 110, the processor 220 updates the storage apparatus information.

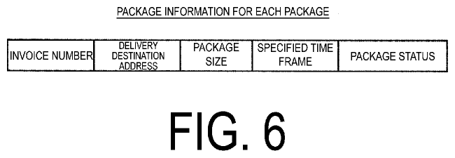

FIG. 6 is a diagram illustrating the package information according to an embodiment.

As illustrated in FIG. 6, the package information includes, for each package, an invoice number for identifying the package, a delivery destination address to which the package is to be delivered, a package size being a size of the package, a specified time frame being a delivery time frame specified for the package, and a package status being a status of the package. The package size includes types such as “S”, “M”, and “L”, for example. The delivery time frame is a time frame in which a time frame (for example, from 9:00 to 21:00) that accepts delivery in a day is divided at predetermined intervals. The delivery time frame includes, for example, types such as (1) a time frame from 9:00 to 12:00, (2) a time frame from 12:00 to 14:00, (3) a time frame from 14:00 to 16:00, (4) a time frame from 16:00 to 18:00, and (5) a time frame from 18:00 to 21:00. The package status includes, for example, (a) an unreserved state in which a reservation is not made yet (reservable), (b) a state in which a reservation is already made (reserved), (c) a state in which the package is stored in the storage box 110 (stored), (d) a state in which the package is delivered to the recipient (delivered to user), and (e) a state in which, when a notification about completion of reservation of the storage box 110 is performed through electronic mail or the like, the recipient makes a selection indicating that the recipient desires attended delivery on the notification screen (attended delivery desired).

The initial state of the package status is (a) reservable. Firstly, when the storage box 110 is reserved for a package, the processor 220 updates the package status of the package from (a) reservable to (b) reserved. Secondly, when the package is stored in the storage box 110, the processor 220 updates the package status of the package from (b) reserved to (c) stored. Thirdly, when the package is retrieved from the storage box 110, the processor 220 updates the package status of the package from (c) stored to (d) delivered to user. Alternatively, firstly, when the storage box 110 is reserved for a package, the processor 220 updates the package status of the package from (a) reservable to (b) reserved. Secondly, when a notification about completion of reservation of the storage box 110 is performed through electronic mail or the like and the recipient makes a selection indicating that the recipient desires attended delivery on the notification screen, the processor 220 updates the package status of the package from (b) reserved to (e) attended delivery desired. Thirdly, when it is determined that attended delivery of the package is performed, the processor 220 updates the package status of the package from (e) attended delivery desired to (d) delivered to user.

The processor 220 executes the prioritization processing of setting priority of each of the packages based on the package information and the reservation processing of reserving the storage boxes 110 in order from a package having high priority based on the package information and the storage apparatus information. This enables efficient reservation of the storage boxes 110.

In an embodiment, in the prioritization processing, the processor 220 sets higher priority to a package whose delivery time frame is early than to a package whose delivery time frame is late. As a result, the storage box 110 is preferentially reserved for a package whose delivery time frame is early.

When the storage box 110 is reserved for a package whose delivery time frame is late, the storage box 110 is in a reserved state (that is, a state waiting for storage) until the late time frame, and accordingly use efficiency of the storage boxes 110 is reduced. Thus, the processor 220 preferentially reserves the storage box 110 for a package whose delivery time frame is early.

When the storage box 110 is reserved for a package whose delivery time frame is early and then the package is stored in the storage box 110 and the package is retrieved, the storage box 110 enters an “available” state again, and the storage box 110 can be reserved for a package whose delivery time frame is late. This enables enhanced use efficiency of the storage boxes 110.

In an embodiment, in the prioritization processing, regarding each delivery time frame, the processor 220 sets higher priority to a package having a large package size than to a package having a small package size. As a result, the storage box 110 is preferentially reserved for a package having a large package size.

The limited number of storage boxes 110 can store a package having a large package size. In contrast, a package having a small package size can be stored in the storage box 110 of any box size. Thus, when the storage box 110 having a large box size is first reserved for a package having a small package size, there may be no storage boxes 110 left that can be reserved for a package having a large package size. In this case, storage capability of the storage box 110 is wasted, and accordingly use efficiency of the storage boxes 110 is reduced.

Thus, the processor 220 preferentially reserves the storage box 110 for a package having a large package size. This enables more secure delivery of a package having a large package size, and enhanced use efficiency of the storage boxes 110.

In an embodiment, regarding each delivery time frame, the processor 220 executes the reservation processing at start timing of the delivery time frame or at timing earlier than the start timing by a predetermined time period (for example, by 5 minutes or by 10 minutes).

When reservation of all of the packages is collectively performed at one time for all of the delivery time frames, fine reservation in consideration of the latest status (availability status) of the storage boxes 110 cannot be performed, and accordingly use efficiency of the storage boxes 110 is reduced.

Thus, for example, for each delivery time frame, the processor 220 executes the reservation processing for each package belonging to the delivery time frame at timing immediately before the delivery time frame. This enables the reservation processing according to the latest status (availability status) of the storage box 110, and accordingly enhanced use efficiency of the storage boxes 110.

In an embodiment, in the reservation processing, the processor 220 selects and reserves the storage box 110 having the smallest box size out of the storage boxes 110 (that is, available storage boxes 110) that can be reserved based on the availability status and that have a box size allowing storage of a reservation target package.

As a specific example, it is assumed that there is a package having a package size of “S”, and an available storage box 110 having a box size of “M” and an available storage box 110 having a box size of “L”. Here, when the available storage box 110 having a box size of “L” is reserved for the package, storage capability of the storage box 110 is wasted, and accordingly use efficiency of the storage boxes 110 is reduced.

Thus, the processor 220 reserves the available storage box 110 having a box size of “M”, instead of the available storage box 110 having a box size of “L”. This enables enhanced use efficiency of the storage boxes 110.

In an embodiment, when package(s) are retrieved from one or more storage boxes 110 and there is an unreserved package, the processor 220 executes the reservation processing, with the unreserved package as a reservation target package.

In other words, the processor 220 manages the unreserved package for which reservation cannot be made, as a package waiting to be reserved (waiting for the storage box 110 to become available), and attempts reservation of the unreserved package again when packages are retrieved from the storage boxes 110. This enables the reservation processing according to the latest status (availability status) of the storage boxes 110, and accordingly more secure delivery of a package and enhanced use efficiency of the storage boxes 110.

### Operation Example of Management Server

Next, an operation example of the management server 200 according to an embodiment will be described.

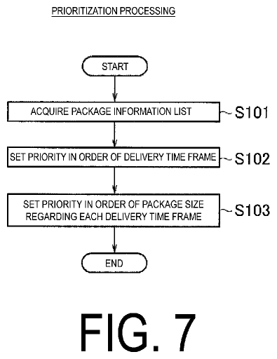

FIG. 7 is a diagram illustrating the prioritization processing according to an embodiment. The processor 220 of the management server 200 executes the prioritization processing illustrated in FIG. 7 once a day and before start of the first delivery time frame (the time frame from 9:00 to 12:00) of the day, for example.

As illustrated in FIG. 7, in Step S101, the processor 220 acquires a package information list being a list of pieces of package information of packages to be delivered on the day. For example, the processor 220 may acquire the package information list by reading the package information list from the storage 230, or may acquire the package information list by the communicator 210 receiving the package information list from the server of the delivery company.

In Step S102, the processor 220 sets the higher priority to each package (each piece of package information) in the package information list in order of the earlier delivery time frame. For example, the processor 220 sets the highest priority to each package specified with the time frame from 9:00 to 12:00, sets the second highest priority to each package specified with the time frame from 12:00 to 14:00, sets the third highest priority to each package specified with the time frame from 14:00 to 16:00, sets the fourth highest priority to each package specified with the time frame from 16:00 to 18:00, and sets the lowest priority to each package specified with the time frame from 18:00 to 21:00. Such prioritization processing may be processing of sorting each package (each piece of package information) in the package information list in ascending order from the early delivery time frame. The processor 220 executes the reservation processing to be described below in order sequentially from top to bottom in the sorted package information list.

In Step S103, regarding each delivery time frame, the processor 220 sets priority to each package (each piece of package information) in the package information list, with high priority being set to a package having a large package size. For example, when there are package #1 having a package size of “S”, package #2 having a package size of “M”, and package #3 having a package size of “L” in a plurality of packages each being specified with the time frame from 9:00 to 12:00, the processor 220 sets the highest priority to package #3, sets the second highest priority to package #2, and sets the lowest priority to package #1. The processor 220 executes similar prioritization processing regarding each of the other delivery time frames. Such prioritization processing may be processing of sorting each package (each piece of package information) in the package information list in ascending order from a package having a large package size regarding each delivery time frame.

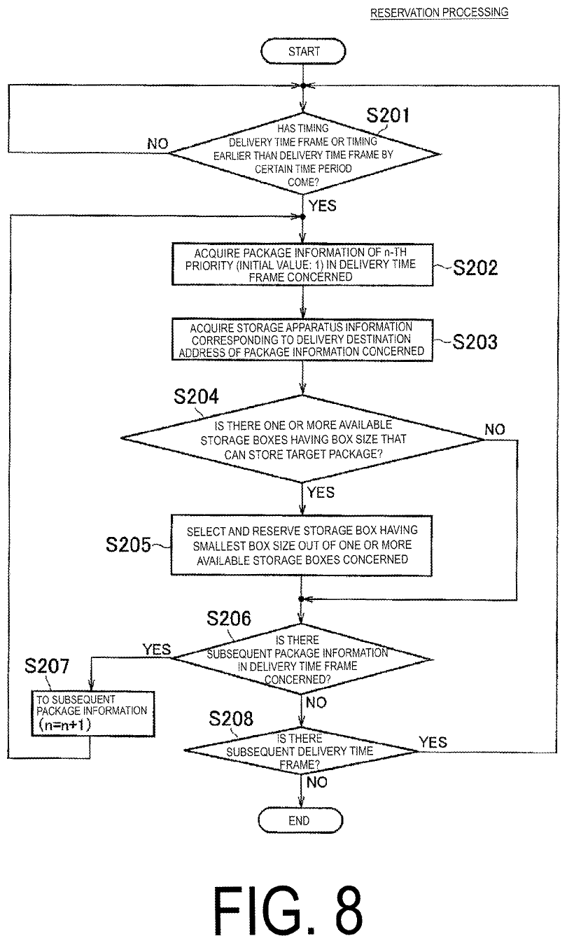

FIG. 8 is a diagram illustrating the reservation processing according to an embodiment. The processor 220 of the management server 200 executes the reservation processing for each delivery time frame after completion of the prioritization processing illustrated in FIG. 7.

As illustrated in FIG. 8, in Step S201, the processor 220 determines whether the current timing is the start timing of the delivery time frame or timing earlier than the start timing by a certain time period.

In a case of “YES” in Step S201, in Step S202, the processor 220 acquires the package information of the package having the highest priority belonging to the delivery time frame out of the package information list after prioritization. In a case of “NO” in Step S201, the processor 220 does not advance the processing to Step S202.

In Step S203, based on the package information acquired in Step S202 and the storage apparatus information for each storage apparatus 100, the processor 220 acquires the storage apparatus information of the storage apparatus 100 installed at the delivery destination address of a package (that is, a reservation target package) corresponding to the package information acquired in Step S202. Specifically, the processor 220 acquires the storage apparatus information including the same address as the delivery destination address included in the package information acquired in Step S202.

In Step S204, based on the package information acquired in Step S202 and the storage apparatus information acquired in Step S203, the processor 220 determines whether there is one or more available storage boxes having a box size that can store the reservation target package in the storage apparatus 100 installed at the delivery destination address of the reservation target package. In a case of “NO” in Step S204, the processor 220 advances the processing to Step S206. In this case, the processor 220 fails to reserve the reservation target package, but manages the unreserved package as a package waiting to be reserved (waiting for the storage box 110 to become available).

In contrast, in a case of “YES” in Step S204, in Step S205, the processor 220 selects and reserves the storage box 110 having the smallest box size out of the one or more available storage boxes having a box size that can store the reservation target package.

In Step S206, the processor 220 determines whether there is subsequent package information (that is, package information of the second priority) belonging to the delivery time frame. In a case of “YES” in Step S206, the processor 220 acquires the subsequent package information (Step S207), and brings the processing back to Step S202.

In contrast, in a case of “NO” in Step S206, in Step S208, the processor 220 ends the reservation processing for the delivery time frame, and determines whether there is a subsequent delivery time frame. In a case of “YES” in Step S208, the processor 220 brings the processing back to Step S201, with the subsequent delivery time frame being a target. In contrast, in a case of “NO” in Step S208, the processor 220 ends the reservation processing for the day.

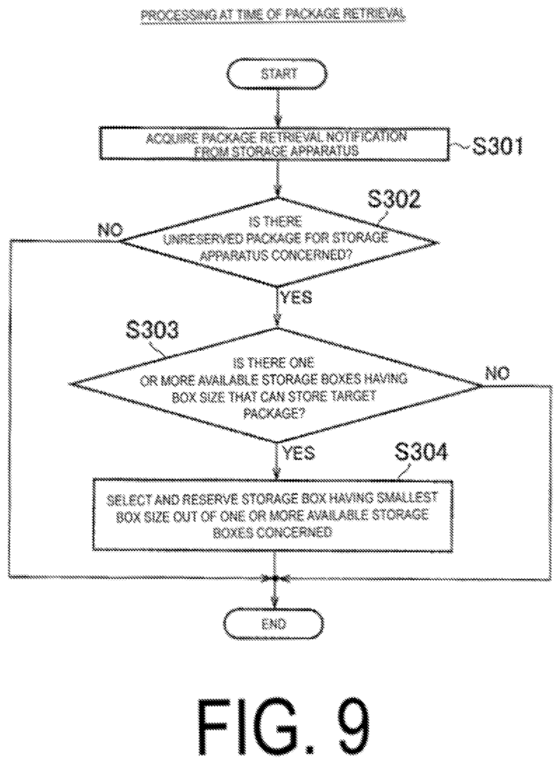

FIG. 9 is a diagram illustrating processing at the time of package retrieval according to an embodiment. When the processor 220 of the management server 200 detects that a package is retrieved from any one of the storage boxes 110, the processor 220 starts the processing at the time of package retrieval.

As illustrated in FIG. 9, in Step S301, the processor 220 acquires a notification indicating that the package has been retrieved from the storage box 110 from the storage apparatus 100 including the storage box 110.

In Step S302, the processor 220 determines whether there is an unreserved package (package waiting for availability) for the storage apparatus 100.

In a case of “YES” in Step S302, in Step S303, with the unreserved package as a reservation target package, the processor 220 determines whether there is one or more available storage boxes having a box size that can store the reservation target package with a method similar to the above. In a case of “NO” in Step S302, the processor 220 ends the processing.

In a case of “YES” in Step S303, in Step S304, the processor 220 selects and reserves the storage box 110 having the smallest box size out of the one or more available storage boxes having a box size that can store the reservation target package. In a case of “NO” in Step S303, the processor 220 ends the processing.

As described in the above, the processor 220 of the management server 200 according to an embodiment executes the prioritization processing of setting priority to each of the packages based on the package information, and the reservation processing of reserving the storage boxes 110 in order from a package having high priority based on the package information and the storage apparatus information. This enables efficient reservation of the storage boxes 110.

### OTHER EMBODIMENTS

A program that causes a computer to execute the processing operations according to the embodiments described above may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

Embodiments have been described above in detail with reference to the drawings, but specific configurations are not limited to those described above, and various alternative designs can be made without departing from the gist of the present disclosure.

1. A management system comprising:
a storage apparatus comprising a storage box configured to store a package to be delivered; and
a server configured to manage the storage apparatus and automatically reserve the storage box configured to store the package, wherein
the server is configured to execute
prioritization processing of setting priority to the package, based on package information related to the package, and
reservation processing of reserving the storage box in order from a package having the priority of high, based on the package information and storage apparatus information related to the storage apparatus.

2. The management system according to claim 1, wherein
the package information comprises information indicating a delivery time frame specified for the package, and
the prioritization processing comprises processing of setting higher priority to a package with the delivery time frame early than to a package with the delivery time frame late.

3. The management system according to claim 2, wherein
the package information further comprises information indicating a package size of the package,
the storage apparatus comprises a plurality of the storage boxes provided for each size, and
in the prioritization processing, regarding each delivery time frame, higher priority is set to a package having the package size large than to a package having the package size small.

4. The management system according to claim 1, wherein the server is configured to execute, regarding each delivery time frame, the reservation processing at start timing of the delivery time frame or at timing earlier than the start timing by a predetermined time period.

5. The management system according to claim 1, wherein
the storage apparatus information indicates a box size and an availability status for each of the plurality of the storage boxes, and
the reservation processing comprises processing of selecting and reserving a storage box having a smallest box size out of the plurality of the storage boxes that can be reserved based on the availability status and that have a box size allowing storage of a reservation target package.

6. The management system according to claim 5, wherein when a package is retrieved from one or more storage boxes and there is an unreserved package, the server executes the reservation processing, with the unreserved package as the reservation target package.

7. A management server configured to manage a storage apparatus comprising a storage box configured to store a package to be delivered, the management server comprising:
a processor configured to automatically reserve the storage box configured to store the package, wherein
the processor is configured to execute
prioritization processing of setting priority to the package, based on package information related to the package, and
reservation processing of reserving the storage box in order from a package having the priority of high, based on the package information and storage apparatus information related to the storage apparatus.

8. A management method of managing a storage apparatus comprising a storage box configured to store a package to be delivered, the management method comprising the steps of:
automatically reserving the storage box configured to store the package, wherein
the reserving comprises
setting priority to the package, based on package information related to the package, and
reserving the storage box in order from a package having the priority of high, based on the package information and storage apparatus information related to the storage apparatus.
